(19) United States
(12) Patent Application Publication
(10) Pub. No.: US 2023/0253730 A1
(43) Pub. Date: Aug. 10, 2023

(54) CONNECTOR COMPONENT AND WIRING MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yoshitaka IKEDA, Mie (JP); Hirokazu KOMORI, Mie (JP); Sho MURAKAMI, Mie (JP)

(21) Appl. No.: 18/010,343

(22) PCT Filed: Jun. 8, 2021
(86) PCT No.: PCT/JP2021/021690

§ 371 Date: Dec. 14, 2022

(30) Foreign Application Priority Data
Jun. 26, 2020 (JP) 2020-110558

(51) Int. Cl. H01R 13/56

(52) U.S. Cl. CPC H01R 13/56

(57) ABSTRACT

An object of the present disclosure is to provide a technology that makes it possible to turn a wire to three or more different directions using one type of cover member. A connector component includes a connector housing in which a cavity is formed, and a cover member that is selectively mounted to the connector housing in one mounting orientation out of three or more different mounting orientations to turn a wire extending from the cavity to a direction corresponding to the one mounting orientation. The cover member includes a restricting portion that restricts the wire and a mounting portion that is integrally formed with the restricting portion and mounted to the connector housing. The cover member is mounted to the connector housing in a mounting orientation corresponding to a combination of a locking portion and a lock catch portion that are locked to each other.

### TECHNICAL FIELD

The present disclosure relates to a connector component and a wiring member.

### BACKGROUND

Patent Document 1 discloses a technology that turns a wire extending from a connector housing to a lateral side using a wire cover mounted to the connector housing. According to Patent Document 1, it is possible to turn a wire to two different directions using one type of wire cover.

### PRIOR ART DOCUMENT

### Patent Document

Patent Document 1: JP 2008-293810 A

### SUMMARY OF THE INVENTION

### Problems to be Solved

It is desired to turn a wire to three or more different directions using one type of wire cover.

Therefore, an object of the present disclosure is to provide a technology that makes it possible to turn a wire to three or more different directions using one type of cover member.

### Means to Solve the Problem

A connector component of the present disclosure includes a connector housing in which a cavity is formed and a cover member that is selectively mounted to the connector housing in one mounting orientation out of three or more different mounting orientations to turn a wire extending from the cavity to a direction corresponding to the one mounting orientation, wherein the cover member includes a restricting portion that restricts a portion of the wire that extends from the cavity in a state in which the portion is bent in a direction that intersects an axial direction of the cavity and a mounting portion that is integrally formed with the restricting portion and mounted to the connector housing, the connector housing has three or more locking portions on an outer surface thereof, the three or more locking portions being spaced apart from each other in a circumferential direction of the connector housing, the mounting portion is provided with at least one lock catch portion capable of locking to the locking portions, and the cover member is mounted to the connector housing in a mounting orientation corresponding to a combination of the locking portion and the lock catch portion that are locked to each other.

### Effect of the Invention

According to the present disclosure, it is possible to turn a wire to three or more different directions using one type of wire cover.

### BRIEF DESCRIPTION OF THE DRAWINGS

FIG. 1 is a perspective view showing a connector component according to Embodiment 1.

FIG. 2 is an exploded perspective view showing the connector component according to Embodiment 1.

FIG. 3 is an exploded plan view showing the connector component according to Embodiment 1.

FIG. 4 is an exploded side view showing the connector component according to Embodiment 1.

FIG. 5 is an exploded side view showing the connector component according to Embodiment 1.

FIG. 6 is a cross-sectional view taken along line VI-VI in FIG. 5.

FIG. 7 is a side view showing a wiring member according to Embodiment 1.

FIG. 8 is an exploded side view showing a connector component according to Embodiment 2.

FIG. 9 is an exploded plan view showing the connector component according to Embodiment 2.

FIG. 10 is a cross-sectional view taken along line X-X in FIG. 8.

FIG. 11 is a cross-sectional view taken along line XI-XI in FIG. 8.

FIG. 12 is an exploded plan view showing a variation of the connector component according to Embodiment 1.

FIG. 13 is an exploded plan view showing a variation of the connector component according to Embodiment 2.

### DETAILED DESCRIPTION TO EXECUTE THE INVENTION

### Description of Embodiments of the Present Disclosure

Initially, modes for carrying out the present disclosure will be enumerated and described.

A connector component of the present disclosure is as follows.

(1) A connector component including: a connector housing in which a cavity is formed; and a cover member that is selectively mounted to the connector housing in one mounting orientation out of three or more different mounting orientations to turn a wire extending from the cavity to a direction corresponding to the one mounting orientation, wherein the cover member includes a restricting portion that restricts a portion of the wire that extends from the cavity in a state in which the portion is bent in a direction that intersects an axial direction of the cavity and a mounting portion that is integrally formed with the restricting portion and mounted to the connector housing, the connector housing has three or more locking portions on an outer surface thereof, the three or more locking portions being spaced apart from each other in a circumferential direction of the connector housing, the mounting portion is provided with at least one lock catch portion capable of locking to the locking portions, and the cover member is mounted to the connector housing in a mounting orientation corresponding to a combination of the locking portion and the lock catch portion that are locked to each other. The mounting portion and the restricting portion are integrally formed, and the cover member is mounted to the connector housing in one orientation, out of the three or more different orientations, corresponding to the combination of the locking portion and the lock catch portion that are locked to each other. These configurations allow the restricting portion to restrict the wire in a state in which the wire is bent in one direction, out of three different directions, corresponding to the mounting orientation in which the cover member is mounted to the connector housing. As a result, it is possible to turn the wire to three or more different directions using one type of cover member.

(2) In the connector component according to clause (1), the locking portions may each have two projections, and the lock catch portion may have a locking piece that fits between the two projections. With this configuration, the locking portion and the lock catch portion are stably locked to each other.

(3) In the connector component according to clause (1) or (2), the mounting portion is provided with a first lock catch portion and a second lock catch portion as the at least one lock catch portion, and the first lock catch portion and the second lock catch portion may be locked to two locking portions out of the three or more locking portions. With this configuration, the first lock catch portion and the second lock catch portion can be locked to the locking portions at two locations that are away from each other in the circumferential direction of the connector housing, and thus, the cover member is stably mounted to the connector housing.

(4) In the connector component according to clause (3), the mounting portion may have a connecting piece that extends along the circumferential direction of the connector housing so as to face the outer surface of the connector housing and connects the first lock catch portion and the second lock catch portion to each other, and the connecting piece may have a window portion in which the locking portion, out of the three or more locking portions, that is located between the two locking portions locked to the first lock catch portion and the second lock catch portion fits. The provision of the connecting piece increases the rigidity of the lock catch portions, thereby making it unlikely for the locking portions and the respective lock catch portions locked to each other to become unlocked from each other. As a result of the locking portion fitting into the window portion, looseness is unlikely to occur between the connector housing and the cover member. With these configurations, the cover member is stably mounted to the connector housing.

(5) In the connector component according to clause (3) or (4), a configuration may be adopted in which the cover member can be mounted to the connector housing by sliding the cover member in a direction that is perpendicular to the axial direction of the cavity and perpendicular to a direction connecting the first lock catch portion and the second lock catch portion. With this configuration, the cover member can be easily mounted to the connector housing.

(6) In the connector component according to any one of clauses (1) to (5), the three or more locking portions may be arranged at positions corresponding to vertexes of a regular polygon. With this configuration, the three or more locking portions can be arranged at rotationally symmetric positions along the circumferential direction of the connector housing.

(7) A wiring member of the present disclosure is a wiring member including: the connector component according to any one of clauses (1) to (6); and a wire whose end portion is inserted in the cavity, wherein a portion of the wire that extends from the cavity is restricted in a bent state by the restricting portion of the cover member. The mounting portion and the restricting portion are integrally formed, and the cover member is mounted to the connector housing in one orientation, out of the three or more different orientations, corresponding to the combination of the locking portion and the lock catch portion that are locked to each other. These configurations allow the restricting portion to restrict the wire in a state in which the wire is bent in one direction, out of three different directions, corresponding to the mounting orientation in which the cover member is mounted to the connector housing. As a result, it is possible to turn the wire to three or more different directions using one type of cover member.

### DETAILED DESCRIPTION OF EMBODIMENTS OF THE PRESENT DISCLOSURE

Specific examples of a connector component and a wiring member of the present disclosure will be described below with reference to the drawings. Note that the present disclosure is not limited to these examples, but rather is indicated by the scope of claims, and is intended to include all modifications within the meaning and scope equivalent to the claims.

### Embodiment 1

Hereinafter, a connector component and a wiring member including the connector component according to Embodiment 1 will be described.

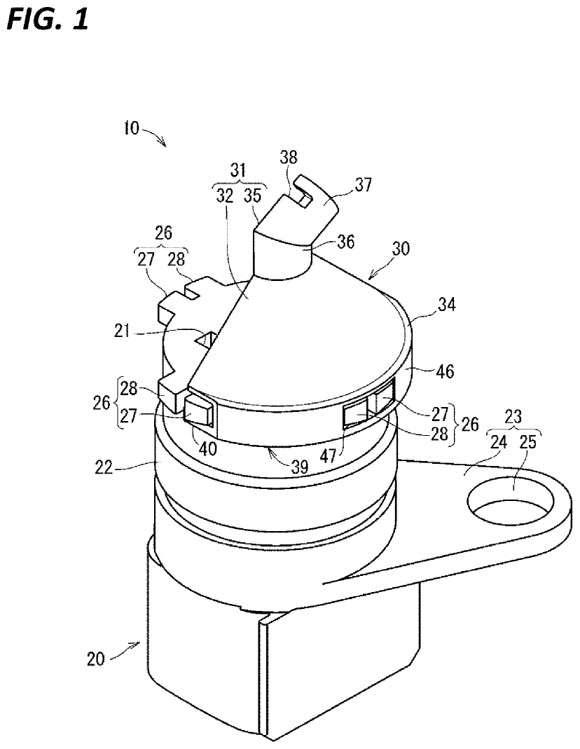

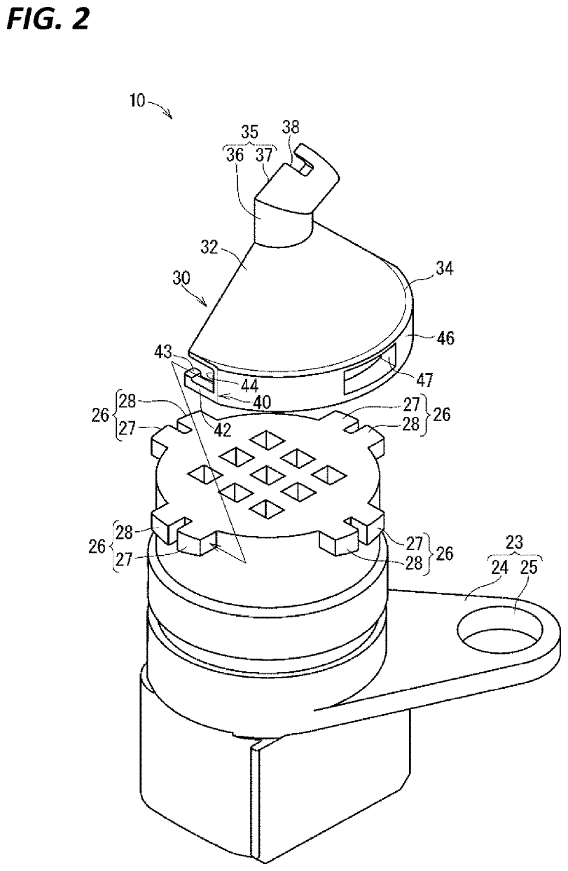

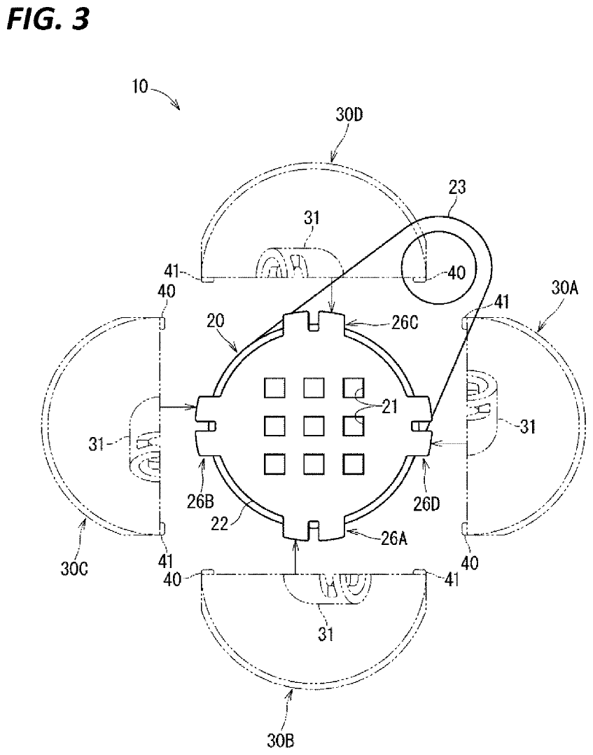

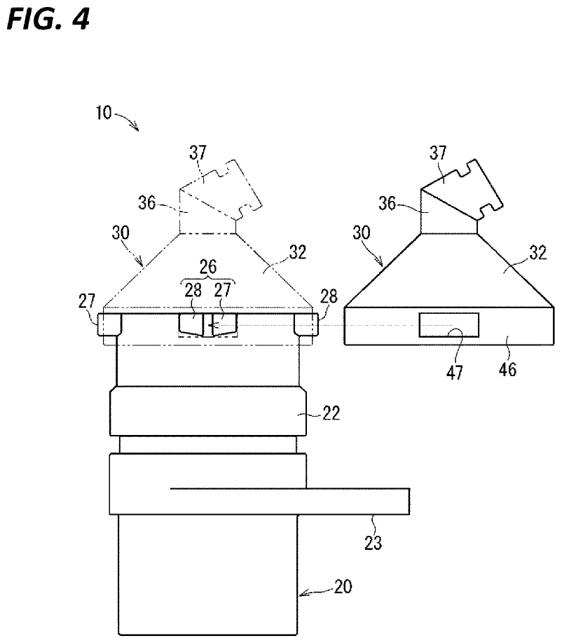

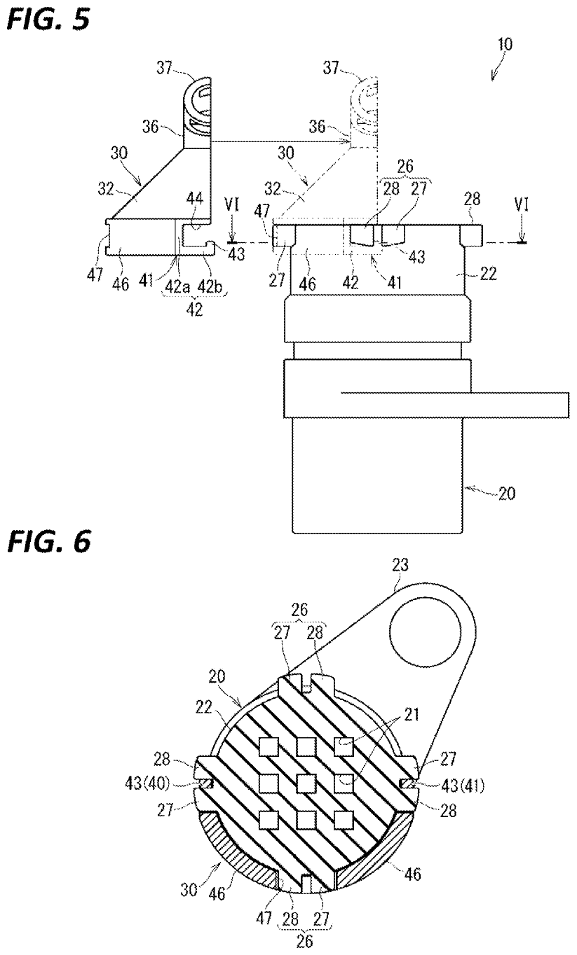

First, the connector component will be described with reference to FIGS. 1 to 6. FIG. 1 is a perspective view showing a connector component 10 according to Embodiment 1. FIG. 2 is an exploded perspective view showing the connector component 10 according to Embodiment 1. FIG. 3 is an exploded plan view showing the connector component 10 according to Embodiment 1. FIG. 4 is an exploded side view showing the connector component 10 according to Embodiment 1. FIG. 5 is an exploded side view showing the connector component 10 according to Embodiment 1. FIG. 6 is a cross-sectional view taken along line VI-VI in FIG. 5.

The connector 10 includes a connector housing 20 and a cover member 30. In FIGS. 4 and 5, the cover member 30 before being mounted to the connector housing 20 is shown in solid lines, and the cover member 30 mounted to the connector housing 20 is shown in dashed double-dotted lines. In addition, the connector housing 20 is viewed from the same direction in FIGS. 4 and 5. The orientation in which the cover member 30 is mounted to the connector housing 20 is different between FIGS. 4 and 5.

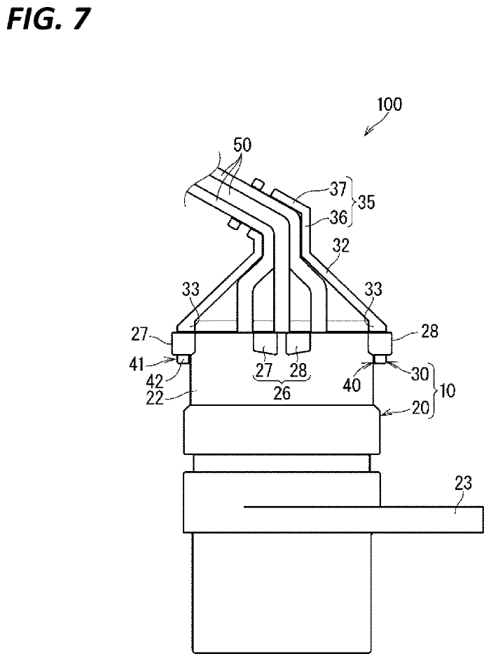

Cavities 21 are formed in the connector housing 20. End portions of wires 50 (see FIG. 7) are accommodated in the cavities 21. The cover member 30 is selectively mounted to the connector housing 20 in one mounting orientation out of three or more different mounting orientations. The cover member 30 turns the wires 50 extending from the cavities 21 to a direction corresponding to the mounting orientation of the cover member 30.

The connector housing 20 includes a main body portion 22, a vehicle body mounting portion 23, and a locking portion 26. The connector housing 20 is, for example, an injection molded article made of an insulating material such as a resin. The cavities 22 are formed in the main body portion 21. Here, nine cavities 21 are arranged in three rows and three columns; however, the number and arrangement of cavities 21 can be set as appropriate. The cavities 21 penetrate the main body portion 22. An opening at one end of each cavity 21 is used as an insertion hole through which a corresponding one of the wires 50 is inserted into the cavity 21. An opening at the other end of the cavity 21 is used to connect the wire 50 to a mating conductor. A portion of the main body portion 22 that includes an end surface in which the openings at the other end of the cavities 21 are formed is defined as a front end portion, and a portion that includes an end surface in which the openings at the one end of the cavities 21 are formed is defined as a rear end portion. The front end portion of the main body portion 22 is configured to fit to the mating connector. The cover member 30 is mounted to the rear end portion of the main body portion 22. Here, an outer surface of the rear end portion of the main body portion 22 has a circular shape.

The vehicle body mounting portion 23 is provided at a position in an intermediate portion of the main body portion 22 in an axial direction of the cavities 21. The vehicle body mounting portion 23 includes a plate-like portion 24. The plate-like portion 24 extends outward from the outer surface of the main body portion 22. A mount hole 25 is formed in the plate-like portion 24. The connector component 10 is mounted to a vehicle body by inserting a fixing member such as a bolt, a clip, or the like into the mount hole 25. Not that the connector housing 20 does not need to include the vehicle body mounting portion 23, and the vehicle body mounting portion 23 may be omitted.

The locking portion 26 is provided on the outer surface of the connector housing 20. Three or more locking portions 26 are provided. The three or more locking portions 26 are spaced apart from each other along the circumferential direction of the connector housing 20. The three or more locking portions 26 are provided in the rear end portion of the connector housing 20. The three or more locking portions 26 are formed in the same shape. The three or more locking portions 26 are arranged at positions corresponding to vertexes of a regular polygon. The wording “three or more locking portions 26 are arranged at positions corresponding to vertexes of a regular polygon” means that an imaginary shape formed by sequentially connecting the three or more locking portions 26 in the circumferential direction of the connector housing 20 is a regular polygon. In the following description, an example in which four locking portions 26 are provided will be used. Here, the four locking portions 26 are arranged at positions corresponding to the four vertexes of a square. The number of locking portions 26 may be three or five or more.

Each locking portion 26 has two projections 27 and 28. The two projections 27 and 28 are spaced apart from each other along the circumferential direction. The projections 27 and 28 are each formed to have a trapezoidal shape in a horizontal cross section (cross section taken along a plane perpendicular to the direction in which the projections 27 and 28 protrude from the connector housing 20). The two projections 27 and 28 are each provided such that the upper and lower bases of the trapezoid extend in the axial direction of the cavities 21. The lower bases of the two projections 27 and 28, which are the longer bases, of the upper and lower bases of the individual trapezoids, face each other, or in other words, face the other projections 28 and 27, respectively, of the two projections 27 and 28. Thus, surfaces (lower surfaces in FIGS. 4 and 5) of the projections 27 and 28 that face toward the front end portion of the main body portion 22 extend such that the distance from each surface to the front end portion of the main body portion 22 gradually increases from the upper base side toward the lower base side. Those surfaces of the projections 27 and 28 that face toward the front end portion of the main body portion 22 serve as guiding surfaces for guiding lock catch portions 40 and 41, which will be described later. Surfaces (upper surfaces in FIGS. 4 and 5) of the projections 27 and 28 that face toward the rear end portion of the main body portion 22 are flush with the end surface in which the openings at the one end of the cavities 21 are formed.

Hereinafter, when there is necessity to distinguish among the four locking portions 26, the locking portions 26 may be individually referred to as locking portions 26A, 26B, 26C, and 26D. On the other hand, when there is no necessity to distinguish among the four locking portions 26, the locking portions 26 may be referred to simply as a locking portion 26.

The cover member 30 includes a restricting portion 31 and a mounting portion 39. The entire cover member 30 is formed in a partial cylinder shape (here, a semicylindrical shape). The cover member 30 is, for example, an injection molded article made of a resin or the like.

The restricting portion 31 restricts those portions of the wires 50 that extend from the cavities 21 in a state in which they are bent in a direction that intersects the axial direction of the cavities 21. The restricting portion 31 has a wire converging portion 32 and a restricting main body portion 35.

The wire converging portion 32 is provided closer to the connector housing 20 than the restricting main body portion 35. The wire converging portion 32 causes the wires 50 extending from the plurality of cavities 21 to converge toward the restricting main body portion 35. In a state in which the cover member 30 is mounted to the connector housing 20, the wire converging portion 32 extends parallel to the axial direction of the cavities 21. The wire converging portion 32 is formed in a semicylindrical shape in the form of a truncated half cone. The inner and outer diameters of the wire converging portion 32 gradually decrease from one end portion that is close to the connector housing 20 toward the other end portion that is close to the restricting main body portion 35. The one end portion of the wire converging portion 32 is provided with an inward protruding portion 33 (see FIG. 7) and an outward protruding portion 34. As a result, the one end portion of the wire converging portion 32 is thicker than the other portions of the wire converging portion 32.

The inward protruding portion 33 is a portion that protrudes inward from the inner circumference of the one end portion of the wire converging portion 32. A portion, of the wire converging portion 32, where the inward protruding portion 33 is provided is continuous while having a constant inner diameter. The inner diameter of the inward protruding portion 33 is smaller than the outer diameter of the end surface of the connector housing 20. In a state in which the cover member 30 is mounted to the connector housing 20, the inward protruding portion 33 faces the end surface of the connector housing 20. Thus, in the state in which the cover member 30 is mounted to the connector housing 20, looseness is unlikely to occur therebetween. Preferably, in the state in which the cover member 30 is mounted to the connector housing 20, the inward protruding portion 33 is in contact with the end surface of the connector housing 20.

The outward protruding portion 34 is a portion that protrudes outward from the outer circumference of the one end portion of the wire converging portion 32. The outward protruding portion 34 is provided on the outer circumference side of the inward protruding portion 33. The outer diameter of the outward protruding portion 34 is larger than the outer diameter of the end surface of the connector housing 20.

The restricting main body portion 35 restricts the wires 50 in a bent state. The restricting main body portion 35 has a base end cylindrical portion 36 and a distal end cylindrical portion 37. The base end cylindrical portion 36 is continuous with the wire converging portion 32. The base end cylindrical portion 36 and the distal end cylindrical portion 37 are formed in semicylindrical shapes that have the same inner diameter and are continuous with each other. The inner diameter of the base end cylindrical portion 36 and the distal end cylindrical portion 37 is equal to the inner diameter of the other end portion of the wire converging portion 32. The base end cylindrical portion 36 extends directly from the other end portion of the wire converging portion 32 and is parallel to the axial direction of the wire converging portion 32. The distal end cylindrical portion 37 is continuous with the base end cylindrical portion 36. The distal end cylindrical portion 37 extends in a direction that intersects the base end cylindrical portion 36. The angle at which the distal end cylindrical portion 37 and the base end cylindrical portion 36 intersect may be any angle. Here, the distal end cylindrical portion 37 extends in a direction that is bent from the base end cylindrical portion 36 by 60 degrees. Recesses 38 are formed in the distal end cylindrical portion 37. The recesses 38 are each formed such that an end portion of the distal end cylindrical portion 37 in the circumferential direction is recessed toward an intermediate portion. The recesses 38 are used for purposes such as positioning of a binding member for binding the wires 50 and the circumference of the distal end cylindrical portion 37 together.

The mounting portion 39 is a portion that is mounted to the connector housing 20. The mounting portion 39 is integrally formed with the restricting portion 31. The mounting portion 39 protrudes from the one end portion of the wire converging portion 32 along the axial direction of the wire converging portion 32. The mounting portion 39 covers the outer surface of the rear end portion of the connector housing 20. An inner surface of the mounting portion 39 has a shape (here, a circular shape) that corresponds to the outer surface of the rear end portion of the connector housing 20. The mounting portion 39 is provided with at least one lock catch portion 40, 41. The lock catch portion 40, 41 is capable of locking to any of the locking portions 26. Here, the mounting portion 39 is provided with two lock catch portions 40 and 41. Therefore, the two lock catch portions 40 and 41 are locked to two locking portions 26 out of the four locking portions 26. The two lock catch portions 40 and 41 serve as an example of a first lock catch portion and a second lock catch portion. The two lock catch portions 40 and 41 have the same shape and are provided in opposite orientations in the circumferential direction. The lock catch portions 40 and 41 each have a support piece 42 and a locking piece 43.

The support pieces 42 protrude from the one end portion of the wire converging portion 32 in a direction away from the wire converging portion 32. The support pieces 42 of the two lock catch portions 40 and 41 are provided in opposite orientations in the circumferential direction. Each support piece 42 is formed in an L shape including a base end-side portion 42a and a distal end-side portion 42b. The base end-side portion 42a extends from the one end portion of the wire converging portion 32 and is parallel to the axial direction of the wire converging portion 32. The distal end-side portion 42b extends from a distal end of the base end-side portion 42a and is parallel to the circumferential direction of the wire converging portion 32. The distal end-side portion 42b is provided in a cantilevered manner. The distal end-side portion 42b is tapered toward its distal end. This facilitates elastic deformation of the distal end-side portions 42b during the locking of the locking portions 26 to the lock catch portions 40 and 41. Here, the distal end-side portions 42b are formed in tapered shapes by making the outer surfaces of the lock catch portions 40 and 41 flat.

The locking pieces 43 protrude from the distal ends of the respective distal end-side portions 42b toward the wire converging portion 32. Each locking piece 43 is configured to fit between the corresponding two projections 27 and 28. The protruding length of the locking pieces 43 is smaller than the protruding length of the base end-side portions 42a. Thus, each locking piece 43 faces the one end portion of the wire converging portion 32 with a certain distance therebetween.

The lock catch portions 40 and 41 each have an accommodating portion 44. The accommodating portion 44 of the lock catch portion 40 accommodates the projection 27 of the two projections 27 and 28, and the accommodating portion 44 of the lock catch portion 41 accommodates the projection 28 of the two projections 27 and 28. Each accommodating portion 44 is constituted by a space surrounded by the support piece 42, the locking piece 43, and the one end portion of the wire converging portion 32. A gap between the locking piece 43 and the one end portion of the wire converging portion 32 constitutes an opening of the accommodating portion 44. The projection 27 or 28 is accommodated into the accommodating portion 44 via the opening.

The two lock catch portions 40 and 41 are provided on opposite sides in the circumferential direction of the wire converging portion 32. The two lock catch portions 40 and 41 are locked to two locking portions 26, out of the four locking portions 26, that are provided along the circumferential direction of the connector housing 20 and are opposite to each other.

The mounting portion 39 has a connecting piece 46. The connecting piece 46 extends along an outer edge of the wire converging portion 32 and connects the two lock catch portions 40 and 41 to each other. The connecting piece 46 protrudes from the one end portion of the wire converging portion 32 between the two lock catch portions 40 and 41 in a direction away from the wire converging portion 32. Two end portions of the connecting piece 46 are continuous with the base end-side portions 42a of the respective support pieces 42. In a state in which the cover member 30 is mounted to the connector housing 20, the connecting piece 46 extends along the circumferential direction of the connector housing 20 so as to face the outer surface of the connector housing 20.

The inner diameter of the lock catch portions 40 and 41 and the connecting piece 46 is approximately equal to the outer diameter of the end surface of the connector housing 20 and is larger than the inner diameter of the inward protruding portion 33. As a result, there is a step between the inward protruding portion 33 and the lock catch portions 40 and 41 and the connecting piece 46. An outer edge of the end surface of the connector housing 20 engage with this step.

The connecting piece 46 traverses a locking portion 26, out of the three or more locking portions 26, that is located between two locking portions 26 locked to the two lock catch portions 40 and 41. Hereinafter, out of the three or more locking portions 26, the locking portion 26 that is located between the two locking portions 26 locked to the two lock catch portions 40 and 41 and that is traversed by the connecting piece 46 may also be referred to as the crossed locking portion 26. A window portion 47 is formed in the connecting piece 46. The crossed locking portion 26 fits into the window portion 47. As a result of the crossed locking portion 26 fitting into the window portion 47, looseness is unlikely to occur between the connector housing 20 and the cover member 30.

The window portion 47 is formed as a through hole that penetrates the connecting piece 46 in thickness direction. The window portion 47 is formed as large as, or larger than, the two projections 27 and 28. Here, the window portion 47 is formed as large as, or slightly larger than, the two projections 27 and 28. Here, the thickness of the connecting piece 46 is equal to or greater than the protruding length of the projections 27 and 28 from the outer surface of the main body portion 22. Therefore, as shown in FIG. 6, the projections 27 and 28 fit within the window portion 47 and do not protrude outward from the outer surface of the connecting piece 46.

The length of the connecting piece 46 along the circumferential direction of the wire converging portion 32 varies depending on the positions of the two lock catch portions 40 and 41. Here, since the two lock catch portions 40 and 41 are provided on the opposite sides, the connecting piece 46 extends half of a full circular path along the circumferential direction of the wire converging portion 32. In the case where the number of locking portions 26 is not four, it is preferable that the positions of the two lock catch portions 40 and 41 are set such that the connecting piece 46 extends half or longer of the full circular path along the circumferential direction of the wire converging portion 32. For example, in the case where the connector housing 20 is provided with three locking portions 26 that are located at positions corresponding to the three vertexes of a regular triangle, it is preferable that the two locking portions 40 and 41 are provided such that the connecting piece 46 extends two thirds of the full circular path.

The cover member 30 is mounted to the connector housing 20 in a mounting orientation corresponding to the combination of locking portions 26 and the lock catch portions 40 and 41 to which the locking portions 26 are locked. Here, the cover member 30 is selectively mounted to the connector housing 20 in one mounting orientation out of the four mounting orientations. This will be described below with reference to FIG. 3.

FIG. 3 shows four cover members 30A, 30B, 30C, and 30D. The four cover members 30A, 30B, 30C, and 30D correspond to the four respective mounting orientations in which the cover member 30 may be mounted to the connector housing 20. The cover member 30 is selectively mounted to the connector housing 20 in a mounting orientation that corresponds to the mounting orientation of one of the four cover members 30A, 30B, 30C, and 30D.

When the cover member 30A positioned in a first mounting orientation is mounted to the connector housing 20, the lock catch portion 40 is locked to a locking portion 26A, and the lock catch portion 41 is locked to a locking portion 26C. When the cover member 30 in the first mounting orientation is mounted to the connector housing 20, the wires 50 are turned upward in the sheet plane in FIG. 3 by the restricting portion 31.

When the cover member 30B positioned in a second mounting orientation is mounted to the connector housing 20, the lock catch portion 40 is locked to a locking portion 26B, and the lock catch portion 41 is locked to a locking portion 26D. When the cover member 30 in the second mounting orientation is mounted to the connector housing 20, the wires 50 are turned rightward in the sheet plane in FIG. 3 by the restricting portion 31.

When the cover member 30C positioned in a third mounting orientation is mounted to the connector housing 20, the lock catch portion 40 is locked to the locking portion 26C, and the lock catch portion 41 is locked to the locking portion 26A. When the cover member 30 in the third mounting orientation is mounted to the connector housing 20, the wires 50 are turned downward in the sheet plane in FIG. 3 by the restricting portion 31.

When the cover member 30D positioned in a fourth mounting orientation is mounted to the connector housing 20, the lock catch portion 40 is locked to the locking portion 26D, and the lock catch portion 41 is locked to the locking portion 26B. When the cover member 30 in the fourth mounting orientation is mounted to the connector housing 20, the wires 50 are turned leftward the sheet plane in FIG. 3 by the restricting portion 31.

Note that, in FIGS. 1, 2, and 4, the cover member 30 is mounted to the connector housing 20 in the first mounting orientation out of the four mounting orientations shown in FIG. 3. In FIGS. 5 and 6, the cover member 30 is mounted to the connector housing 20 in the second mounting orientation out of the four mounting orientations shown in FIG. 3.

The cover member 30 can be mounted to the connector housing 20 by sliding the cover member 30 in a direction that is perpendicular to the axial direction of the cavities 21 and perpendicular to the direction connecting the two lock catch portions 40 and 41. This will be described below with reference to FIG. 5. In a state in which the cover member 30 is in a position shown in the solid lines in FIG. 5 relative to the connector housing 20, the left-right direction in FIG. 5 is the direction that is perpendicular to the axial direction of the cavities 21 and perpendicular to the direction connecting the two lock catch portions 40 and 41. In the state in which the cover member 30 is in the position shown in the solid lines in FIG. 5 relative to the connector housing 20, the accommodating portions 44 of the two lock catch portions 40 and 41 are in positions in which the accommodating portions 44 open in the same direction and face the respective locking portions 26 to which the lock catch portions 40 and 41 are to be locked.

When the cover member 30 is moved rightward in FIG. 5 from the position shown in the solid lines in FIG. 5 toward the connector housing 20, the locking pieces 43 of the lock catch portions 40 and 41 eventually come into contact with guiding surfaces of the respective locking portions 26. When the cover member 30 is further moved rightward in FIG. 5, while the locking pieces 43 slide on the guiding surfaces, the support pieces 42 elastically deform so that the openings of the accommodating portions 44 widen. At this time, in each of the lock catch portions 40 and 41, one of the projections 27 and 28 is accommodated into the accommodating portion 44, and the crossed locking portion 26 is gradually accommodated into the window portion 47. Then, when the cover member 30 reaches a position shown in phantom lines in FIG. 5 relative to the connector housing 20, the locking pieces 43 go over the guiding surfaces and elastically return to their original shapes. The elastically returned locking pieces 43 each fit between the two projections 27 and 28. Thus, the locking portions 26 are locked to the respective lock catch portions 40 and 41. At this time, in each of the lock catch portions 40 and 41, one of the projections 27 and 28 is accommodated in the accommodating portion 44. Also, the crossed locking portion 26 is accommodated in the window portion 47.

### Wiring Member

FIG. 7 is a side view showing a wiring member 100 according to Embodiment 1. In FIG. 7, the cover member 30 is mounted to the connector housing 20 in the third mounting orientation out of the four mounting orientations shown in FIG. 3.

The wiring member 100 includes the above-described connector component 10 and wires 50. End portions of the wires 50 are inserted in the cavities 21. For example, terminals, which are not shown, are provided at the end portions of the wires 50. The terminals and portions of the wires 50 that are connected to the terminals are accommodated in the cavities 21. Portions of the wires 50 that extend from the cavities 21 are restricted in a bent state by the restricting portion 31 of the cover member 30.

The portions of the wires 50 that extend from the cavities 21 are made to converge together into the base end cylindrical portion 36 of the restricting main body portion 35 by the wire converging portion 32. The wires 50 converging into the base end cylindrical portion 36 extend from the base end cylindrical portion 36 toward the distal end cylindrical portion 37 along the restricting main body portion 35. As a result, the wires 50 are restricted in a state in which they are bent in a direction that intersects the axial direction of the cavities 21.

Note that, in the case where the cover 30 has a semicylindrical shape as in the present example, it is preferable that the wires 50 and the restricting main body portion 35 are bound together by a binding member or the like, which is not shown. Such a binding member may be, for example, a piece of pressure-sensitive adhesive tape or a cable tie.

### Effects and the Like of Embodiment 1

According to the connector component 10 and the wiring member 100 including the connector component 10, which are configured as described above, the mounting portion 39 and the restricting portion 31 are integrally formed. Furthermore, the cover member 30 is mounted to the connector housing 20 in one mounting orientation, out of three or more different mounting orientations, corresponding to the combination of locking portions 26 and the lock catch portions 40 and 41 to which the locking portions 26 are locked. These configurations allow the restricting portion 31 to restrict the wires 50 in a state in which the wires 50 are bent in one direction, out of three or more different directions, corresponding to the mounting orientation in which the cover member 30 is mounted to the connector housing 20. Thus, it is possible to turn the wires 50 to three or more different directions using the one type of cover member 30.

Each locking portion 26 has two projections 27 and 28, and the lock catch portions 40 and 41 each have the locking piece 43 that fits between the corresponding two projections 27 and 28. Thus, the locking portions 26 and the respective lock catch portions 40 and 41 are stably locked to each other.

The two lock catch portions 40 and 41 are locked to two locking portions 26 out of three or more locking portions 26. With this configuration, the two lock catch portions 40 and 41 can be locked to locking portions 26 at two locations that are away from each other in the circumferential direction of the connector housing 20, and thus, the cover member 30 is stably mounted to the connector housing 20.

The provision of the connecting piece 46 increases the rigidity of the lock catch portions 40 and 41, thereby making it unlikely for the locking portions 26 and the respective lock catch portions 40 and 41 locked to each other to become unlocked from each other. As a result of the crossed locking portion 26 fitting into the window portion 47, looseness is unlikely to occur between the connector housing 20 and the cover member 30. With these configurations, the cover member 30 is stably mounted to the connector housing 20.

The cover member 30 can be mounted to the connector housing 20 by sliding the cover member 30 in a direction that is perpendicular to the axial direction of the cavities 21 and perpendicular to the direction connecting the two lock catch portions 40 and 41. With this configuration, the cover member 30 can be easily mounted to the connector housing 20.

The three or more locking portions 26 are arranged at positions corresponding to vertexes of a regular polygon. With this configuration, the three or more locking portions 26 can be arranged at rotationally symmetric positions along the circumferential direction of the connector housing 20.

### Embodiment 2

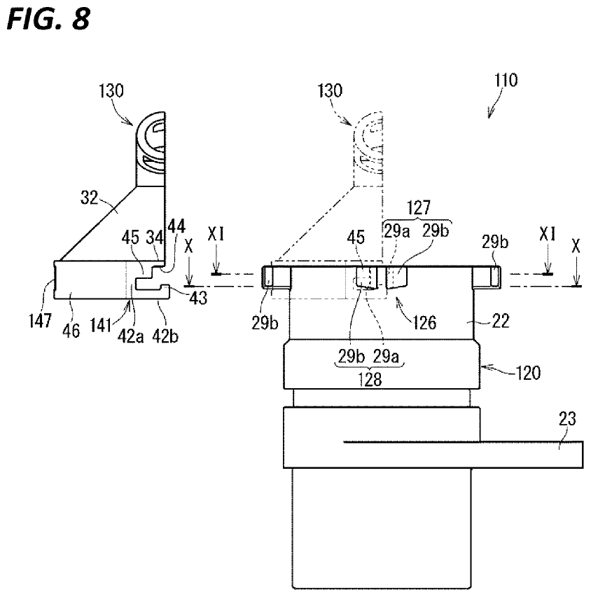

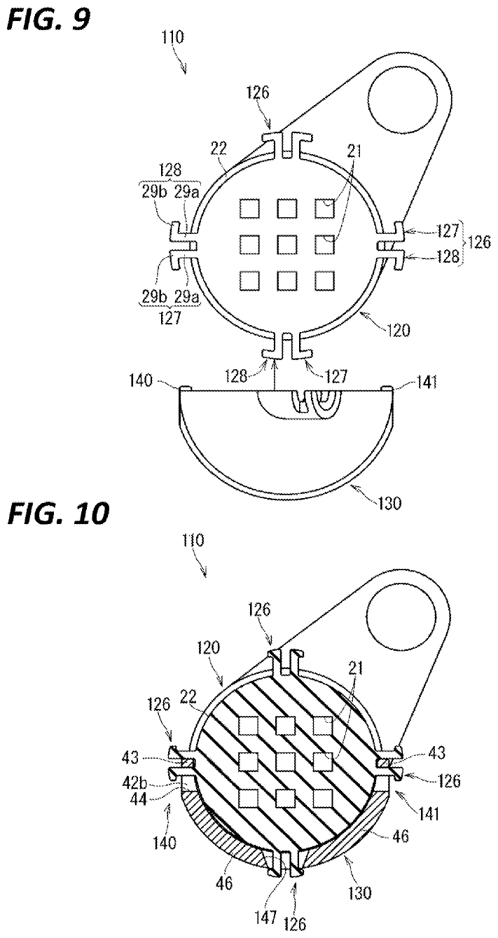

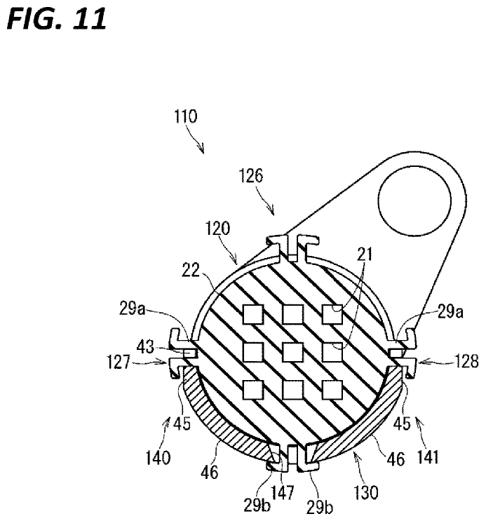

A connector component according to Embodiment 2 will be described. FIG. 8 is an exploded side view showing a connector component 110 according to Embodiment 2. FIG. 9 is an exploded plan view showing the connector component 110 according to Embodiment 2. FIG. 10 is a cross-sectional view taken along line X-X in FIG. 8. FIG. 11 is a cross-sectional view taken along line XI-XI in FIG. 8. Note that, in the following description of the present embodiment, constituent elements that are the same as those described above are given the same reference numerals, and a description thereof will be omitted.

In the connector component 110, locking portions 126 of a connector housing 120 and lock catch portions 140 and 141 of a cover member 130 differ from the locking portions 26 of the above-described connector component 20 and the lock catch portions 40 and 41 of the above-described cover member 30 in terms of shape.

Each locking portion 126 has hook-shaped projections 127 and 128. The projections 127 and 128 are each formed in an L shape. The projections 127 and 128 each have a column portion 29a and a hooking piece 29b. The column portion 29a protrudes outward on the outer circumference side from the outer surface of the main body portion 22. The protruding length of the column portion 29a is approximately equal to the thickness of a mounting portion 139. The guiding surfaces of the above-described projections 27 and 28 are provided on the column portions 29a of the respective projections 127 and 128. The hooking pieces 29b protrude from distal ends of the respective column portions 29a in the circumferential direction of the connector housing 120. The hooking pieces 29b of the two projections 127 and 128 protrude in opposite directions to each other (directions opposite to the directions in which the projections 127 and 128 face each other).

The lock catch portions 140 and 141 are shaped like the above-described lock catch portions 40 and 41, with hooking portions 45 further provided, respectively. Each hooking portion 45 protrudes so as to block a portion of the corresponding accommodating portion 44. Here, the hooking portion 45 protrudes from the base end-side portion 42a of the support piece 42 and the one end portion of the wire converging portion 32 so as to block a portion of the accommodating portion 44. In a state in which the locking portions 126 are locked to the respective lock catch portions 140 and 141, each column portion 29a fits in a position between the hooking portion 45 and the locking portion 43, of the accommodating portion 44, and the hooking piece 29b is located on the outer circumference side of the hooking portion 45. If the connector housing 120 and the cover member 130 attempt to move relative to each other in the direction connecting the two lock catch portions 140 and 141, one of the hooking portions 45 and a corresponding one of the hooking pieces 29b engage with each other.

In each of the lock catch portions 140 and 141, the hooking portion 45 does not reach the distal end-side portion 42b of the support piece 42. The hooking portion 45 and the distal end-side portion 42b of the support piece 42 face each other with a distance left therebetween. With this configuration, as in the case of the lock catch portions 40 and 41, the distal end-side portions 42b of the support pieces 42 of the lock catch portions 140 and 141 easily elastically deform such that the openings of the accommodating portions 44 widen.

In addition, in the connector component 110, a window portion 147 of the cover member 130 differs from the window portion 47 of the above-described cover member 30 in terms of shape. As shown in FIG. 11, here, the crossed locking portion 126 is locked to the window portion 147. For this purpose, an opening of the window portion 147 on the outer surface side thereof is formed as large as, or larger than, the column portions 29a of the two projections 127 and 128 and smaller than the hooking pieces 29b of the two projections 127 and 128. The hooking pieces 29b of the two projections 127 and 128 of the crossed locking portion 126 are locked to a peripheral edge of the outer surface-side opening of the window portion 147.

An inner circumferential surface of the through hole of the window portion 147 is made as a guiding surface so that the cover member 130 can be mounted to the connector housing 120 by sliding the cover member 130 in a direction that is perpendicular to the axial direction of the cavities 21 and perpendicular to the direction connecting the two lock catch portions 140 and 141. That is to say, the inner surface-side opening of the window portion 147 is formed larger than the outer surface-side opening. The inner surface-side opening of the window portion 47 is formed as large as, or larger than, the hooking pieces 29b of the two projections 127 and 128. In addition, the inner circumferential surface of the through hole of the window portion 147 is formed such that the size of the through hole gradually increases from the outer surface-side opening toward the inner surface-side opening.

Now, locking of the locking portions 126 to the lock catch portions 140 and 141 will be described with reference to FIG. 8. When the cover member 130 is moved rightward in FIG. 8 from a position shown in solid lines in FIG. 8 toward the connector housing 120, the locking pieces 43 of the lock catch portions 140 and 141 eventually come into contact with the guiding surfaces (surfaces facing downward in FIG. 8, of the column portions 29a) of the corresponding locking portions 126. When the cover member 130 is further moved rightward in FIG. 8, while the locking pieces 43 slide on the guiding surfaces of the column portions 29a, the support pieces 42 elastically deform so that the openings of the accommodating portions 44 widen. At this time, in each of the lock catch portions 140 and 141, the column portion 29a of one of the projections 127 and 128 is accommodated into the accommodating portion 44. Then, when the cover member 130 reaches a position shown in phantom lines in FIG. 5 relative to the connector housing 120, the locking pieces 43 go over the guiding surfaces of the column portions 29a and elastically return to their original shapes. The elastically returned locking pieces 43 each fit between the column portions 29a of the two projections 127 and 128. Also, the hooking pieces 29b are located on the outer circumference side of the hooking portions 45. Thus, the locking portions 126 are locked to the respective lock catch portions 140 and 141.

When the locking portions 126 are locked to the lock catch portions 140 and 141, the crossed locking portion 126 is also locked to the window portion 147. This will be described with reference to FIG. 8. When the cover member 130 is moved rightward in FIG. 8 from the position shown in the solid lines in FIG. 8 toward the connector housing 120, the hooking pieces 29b of the crossed locking portion 126 are eventually inserted into the window portion 147 from the inner surface-side opening of the window portion 147 and come into contact with the guiding surface of the window portion 147. When the cover member 130 is further moved rightward in FIG. 8, while the hooking pieces 29b of the crossed locking portion 126 slide on the guiding surface of the window portion 147, the crossed locking portion 126 elastically deform so that the distance between the two hooking pieces 29b decreases. For example, the hooking pieces 29b elastically deform such that distal end portions of the hooking pieces 29b approach the corresponding column portions 29a, or the column portions 29a elastically deform such that the two projections 127 and 128 approach each other. At this time, the hooking pieces 29b gradually go over the outer surface-side opening of the window portion 147 from the base end portion side where the hooking pieces 29b are connected to the column portions 29a, respectively. Then, when the cover member 130 reaches the position shown in the phantom lines in FIG. 5 relative to the connector housing 120, the entireties of the hooking pieces 29b go over the outer surface-side opening of the window portion 147, and the crossed locking portion 126 elastically return to its original shape. The elastically returned hooking pieces 29b are located on the outer circumference side of the peripheral edge of the outer surface-side opening of the window portion 147. Thus, the crossed locking portion 126 is locked to the window portion 147.

According to the connector component 110 that is configured as described above and the wiring member including the connector component 110 as well, similar effects to those of the connector component 10 and the wiring member 100 including the connector component 10 according to Embodiment 1 can be achieved. Furthermore, according to the connector component 110 and the wiring member including the connector component 110, as a result of the hooking pieces 29b being provided, the cover member 130 is even more stably mounted to the connector housing 120.

### Variations

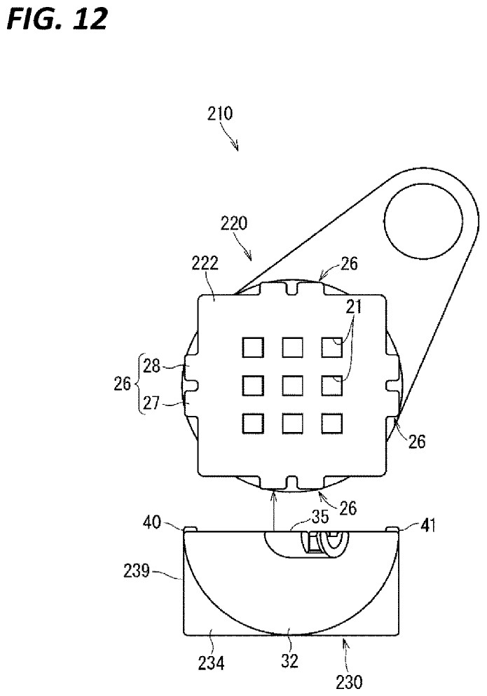

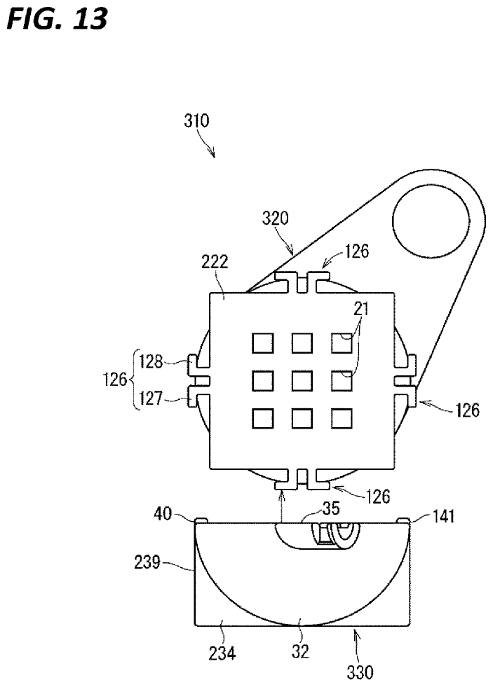

FIG. 12 is an exploded plan view showing a variation of the connector component 10 according to Embodiment 1. FIG. 13 is an exploded plan view showing a variation of the connector component 110 according to Embodiment 2.

In connector components 210 and 310 according to the variations, the outer surface shape of the rear end portion of a main body portion 222 differs from the outer surface shape of the rear end portion of the above-described main body portion 22. That is to say, in the foregoing examples, a configuration has been described above in which the outer surface of the rear end portion of the main body portion 22 has a circular shape, but this is not an essential configuration. The outer surface of the rear end portion of the main body portion 222 may have a quadrilateral shape like a connector housing 220 shown in FIG. 12 and a connector housing 320 shown in FIG. 13. In the connector housings 220 and 320, the outer surface of the rear end portion of the main body portion 222 has a square shape, but the outer surface may also have other quadrilateral shapes such as a rectangular shape. Furthermore, the outer surface of the rear end portion of the main body portion 222 may have a shape other than a circular shape and a quadrilateral shape. In the connector housings 220 and 320, it is preferable that the locking portions 26 and 126 are located in intermediate portions between corners of the outer surface of the main body portion 222, rather than at the corners thereof. Also, it is preferable that, in the cover members 230 and 330 corresponding to the respective connector housings 220 and 320, an outward protruding portion 234 and a mounting portion 239 have a quadrilateral shape corresponding to the rear end portion of the main body portion 222.

In addition to these, although a configuration has been described above in which the locking portions 26 each have two projections 27 and 28 and the lock catch portions 40 and 41 each have the locking piece 43 that fits between the two projections 27 and 28, this is not an essential configuration. As long as the locking portions 26 can be locked to and the lock catch portions 40 and 41, these portions may have any shapes. For example, each locking portion 26 may have a single projection 27 or 28.

Furthermore, although a configuration has been described above in which the mounting portion 39 is provided with two lock catch portions 40 and 41, this is not an essential configuration. The number of locking portions may be one or three or more.

Furthermore, although a configuration has been described above in which the mounting portion 39 has the connecting piece 46 in which the window portion 47 is formed, this is not an essential configuration. The mounting portion 39 may not have the connecting piece 46 in which the window portion 47 is formed. For example, the mounting portion may have only the lock catch portions 40 and 41. Alternatively, for example, the mounting portion may be provided with a reinforcement piece that is shorter than the connecting piece 46 and reinforces the lock catch portions 40 and 41. Such a reinforcement piece may have, for example, a shape in which a portion including the window portion 47, of the above-described connecting piece 46 is formed as a recess.

Furthermore, although a configuration has been described above in which the cover member 30 can be mounted to the connector housing 20 by sliding the cover member 30 in the direction that is perpendicular to the axial direction of the cavities 21 and perpendicular to the direction connecting the two locking edge portions 40 and 41, this is not an essential configuration. For example, the cover member 30 may be mounted to the connector housing 20 by sliding the cover member 30 in the axial direction of the cavities 21, or the like. Furthermore, the connector housing 20 and the cover member 30 may be configured such that the cover member 30 cannot be mounted by sliding it. For example, instead of a configuration in which the two lock catch portions are elastically deformed by a reaction force from the locking portions during the sliding movement, a worker may elastically deform the two lock catch portions so as to spread them apart.

Furthermore, although a configuration has been described above in which the three or more locking portions 26 are arranged at positions corresponding to vertexes of a regular polygon, this is not an essential configuration. For example, a configuration may also be adopted in which three locking portions are arranged and the arrangement of the three locking portions is such that one of the above-described four locking portions 26 is omitted.

Furthermore, although a configuration has been described above in which only one cover member 30 formed in a semicylindrical shape is mounted to the connector housing 20 and the cover member 30 partially covers the periphery of the wires 50, this is not an essential configuration. A cover member may be provided that is capable of covering the entire periphery of the wires 50. For example, a configuration may also be adopted in which two cover members, each formed in a semicylindrical shape, are mounted to the connector housing 20 and the cover members together cover the entire periphery of the wires 50. The two cover members may be connected to each other by a hinge or the like so that they can be opened and closed.

Note that the various configurations described in the embodiments and the variations above can be combined as appropriate unless they are technically contradictory to each other.

### LIST OF REFERENCE NUMERALS

10, 110, 210, 310 Connector component

20, 120, 220, 320 Connector housing

21 Cavity

22, 222 Main body portion

23 Vehicle body mounting portion

24 Plate-like portion

25 Mount hole

26, 26A, 26B, 26C, 26D, 126 Locking portion

27, 28, 127, 128 Projection

29a Column portion

29b Hooking piece

30, 130 Cover member

31 Restricting portion

32 Wire converging portion

33 Inward protruding portion

34 Outward protruding portion

35 Restricting main body portion

36 Base end cylindrical portion

37 Distal end cylindrical portion

38 Recess

39 Mounting portion

40, 140 First lock catch portion (Lock catch portion)

41, 141 Second lock catch portion (Lock catch portion)

42 Support piece

42a Base end-side portion

42b Distal end-side portion

43 Locking piece

44 Accommodating portion

45 Hooking portion

46 Connecting piece

47, 147 Window portion

50 Wire

100 Wiring member

1. A connector component comprising:
a connector housing in which a cavity is formed; and
a cover member that is selectively mounted to the connector housing in one mounting orientation out of three or more different mounting orientations to turn a wire extending from the cavity to a direction corresponding to the one mounting orientation,
wherein the cover member includes a restricting portion that restricts a portion of the wire that extends from the cavity in a state in which the portion is bent in a direction that intersects an axial direction of the cavity and a mounting portion that is integrally formed with the restricting portion and mounted to the connector housing,
the connector housing is provided with three or more locking portions on an outer surface thereof, the three or more locking portions being spaced apart from each other in a circumferential direction of the connector housing,
the mounting portion is provided with at least one lock catch portion capable of locking to the locking portions,
the cover member is mounted to the connector housing in a mounting orientation corresponding to a combination of the locking portion and the lock catch portion that are locked to each other,
the mounting portion is provided on one end side of the cover member and the restricting portion is provided closer to another end side of the cover member than the mounting portion,
the cover member has a partial cylinder shape that extends in a groove-like form from the one end side on which the mounting portion is provided to the other end side from which the wire extends and that partially covers a periphery of the wire,
the restricting portion has a portion that extends from the one end side toward the other end side while bending, and
the wire extends along the portion that extends while bending, of the restricting portion and is thereby restricted so as to extend from the other end side of the cover member in the direction restricted by the restricting portion.

2. The connector component according to claim 1,
wherein the locking portions each have two projections, and
the lock catch portion has a locking piece that fits between the two projections.

3. The connector component according to claim 1,
wherein the mounting portion is provided with a first lock catch portion and a second lock catch portion as the at least one lock catch portion, and
the first lock catch portion and the second lock catch portion are locked to two locking portions out of the three or more locking portions.

4. The connector component according to claim 3,
wherein the mounting portion has a connecting piece that extends along the circumferential direction of the connector housing so as to face the outer surface of the connector housing and connects the first lock catch portion and the second lock catch portion to each other, and
the connecting piece has a window portion in which the locking portion, out of the three or more locking portions, that is located between the two locking portions locked to the first lock catch portion and the second lock catch portion fits.

5. The connector component according to claim 3,
wherein the cover member can be mounted to the connector housing by sliding the cover member in a direction that is perpendicular to the axial direction of the cavity and perpendicular to a direction connecting the first lock catch portion and the second lock catch portion.

6. The connector component according to claim 1,
wherein the three or more locking portions are arranged at positions corresponding to vertexes of a regular polygon.

7. A wiring member comprising:
the connector component according to claim 1; and
a wire whose end portion is inserted in the cavity,
wherein a portion of the wire that extends from the cavity is restricted in a bent state by the restricting portion of the cover member.

8. A connector component comprising:
a connector housing in which a cavity is formed; and
a cover member that is selectively mounted to the connector housing in one mounting orientation out of three or more different mounting orientations to turn a wire extending from the cavity to a direction corresponding to the one mounting orientation,
wherein the cover member includes a restricting portion that restricts a portion of the wire that extends from the cavity in a state in which the portion is bent in a direction that intersects an axial direction of the cavity and a mounting portion that is integrally formed with the restricting portion and mounted to the connector housing,
the connector housing is provided with three or more locking portions on an outer surface thereof, the three or more locking portions being spaced apart from each other in a circumferential direction of the connector housing,
the mounting portion is provided with at least one lock catch portion capable of locking to the locking portions,
the cover member is mounted the connector housing in a mounting orientation corresponding to a combination of the locking portion and the lock catch portion that are locked to each other,
the mounting portion is provided with a first lock catch portion and a second lock catch portion as the at least one lock catch portion,
the first lock catch portion and the second lock catch portion are capable of locking to two respective locking portions out of the three or more locking portions, and
the cover member is mounted to the connector housing by sliding the cover member in a locking direction that is perpendicular to the axial direction of the cavity and perpendicular to a direction connecting the first lock catch portion and the second lock catch portion, and thereby causing the first lock catch portion and the second lock catch portion to be locked to the respective locking portions in the locking direction.

9. The connector component according to claim 8,
wherein the cover member has a partial cylinder shape,
the mounting portion is provided on one end side of the cover member,
the wire is restricted so as to extend from another end side of the cover member in the direction restricted by the restricting portion, and
a direction of the sliding is a direction that connects a bottom of the cover member having the partial cylinder shape and an opening of the cover member located on an opposite side to the bottom.

10. A wiring member comprising:
a connector component; and
a wire whose end portion is inserted in a cavity of the connector component,
the connector component including:
a connector housing in which the cavity is formed;
a cover member that is selectively mounted to the connector housing in one mounting orientation out of three or more different mounting orientations to turn a wire extending from the cavity to a direction corresponding to the one mounting orientation; and
a binding member that binds the wire and a periphery of the cover member together,
wherein the cover member includes a restricting portion that restricts a portion of the wire that extends from the cavity in a state in which the portion is bent in a direction that intersects an axial direction of the cavity and a mounting portion that is integrally formed with the restricting portion and mounted to the connector housing,
the connector housing is provided with three or more locking portions on an outer surface thereof, the three or more locking portions being spaced apart from each other in a circumferential direction of the connector housing,
the mounting portion is provided with at least one lock catch portion capable of locking to the locking portions,
the cover member is mounted the connector housing in a mounting orientation corresponding to a combination of the locking portion and the lock catch portion that are locked to each other,
the mounting portion is provided on one end side of the cover member and the restricting portion is provided closer to another end side of the cover member than the mounting portion,
the cover member has a partial cylinder shape that extends in a groove-like form from the one end side on which the mounting portion is provided to the other end side from which the wire extends and that partially covers a periphery of the wire,
the restricting portion has a portion that extends from the one end side toward the other end side while bending,
the wire extends along the portion that extends while bending, of the restricting portion and is thereby restricted so as to extend from the other end side of the cover member in the direction restricted by the restricting portion, and
the binding member binds the wire and the restricting portion together on the other end side of the cover member.

11. The wiring member according to claim 10,
wherein a terminal is provided at the end portion of the wire, and
the terminal and a portion of the wire that is connected to the terminal are accommodated in the cavity of the connector housing.

12. The connector component according to claim 1,
wherein the restricting portion has a wire converging portion with an inner diameter gradually decreasing from the one end side toward the other end side, and a restricting main body portion that is located on the other end side relative to the wire converging portion and provided with the portion that extends while bending.
